(19) United States
(12) Patent Application Publication
(10) Pub. No.: US 2016/0189840 A1
(43) Pub. Date: Jun. 30, 2016

(54) ELECTRONIC COMPONENT AND METHOD OF MANUFACTURING THE SAME

(71) Applicant: SAMSUNG ELECTRO-MECHANICS CO., LTD., Suwon-Si (KR)

(72) Inventors: Jin Mo AHN, Suwon-Si (KR); Yun Suk OH, Suwon-Si (KR)

(21) Appl. No.: 14/949,425

(22) Filed: Nov. 23, 2015

(30) Foreign Application Priority Data
Dec. 30, 2014 (KR) 10-2014-0194239

(51) Int. Cl. H01F 5/04; H01F 41/04; H01F 3/08; H01F 5/00; H01F 27/29

(52) U.S. Cl. CPC H01F 5/04; H01F 5/003; H01F 27/292; H01F 3/08; H01F 41/046

(57) ABSTRACT

An electronic component includes a magnetic body, and a coil pattern embedded in the magnetic body and including internal coil parts having a spiral shape and lead parts connected to ends of the internal coil parts and externally exposed from the magnetic body. The lead parts include a plurality of protruding portions spaced apart from each other and connected to the ends of the internal coil parts to protrude externally from the ends of the internal coil parts.

### CROSS-REFERENCE TO RELATED APPLICATION

This application claims the priority and benefit of Korean Patent Application No. 10-2014-0194239 filed on Dec. 30, 2014, with the Korean Intellectual Property Office, the disclosure of which is incorporated herein by reference.

### BACKGROUND

The present disclosure relates to an electronic component and a method of manufacturing the same.

An inductor, an electronic component, is a representative passive element configuring an electronic circuit, together with a resistor and a capacitor, to remove noise.

A thin film type inductor is manufactured by forming coil patterns by a plating process, hardening a magnetic powder-resin composite in which a magnetic powder and a resin are mixed with each other to manufacture a magnetic body, and then forming external electrodes on outer surfaces of the magnetic body.

In the case of a thin film type inductor, in accordance with recent changes such as increasing complexity, multifunctionalization, slimming, or the like of a device, attempts to slim inductors continue. Thus, technology in which high performance and reliability can be secured despite the trend toward slimness of electronic components is required.

### SUMMARY

An aspect of the present disclosure may provide an electronic component having improved electrical characteristics and reliability against thermal shock, and the like, by securing sufficient coupling force between internal coil regions and external electrodes, and a method having efficient manufacturing of the electronic component. In addition, as the coupling force between the internal coil regions and the external electrodes is improved, breakage defects, which may be caused at the time of manufacturing a slimmed electronic component, may be reduced.

According to an aspect of the present disclosure, an electronic component may include a magnetic body, and a coil pattern embedded in the magnetic body and including internal coil patterns having a spiral shape and lead parts connected to ends of the internal coil parts and externally exposed from the magnetic body. The lead parts may include a plurality of protruding portions spaced apart from each other and connected to the ends of the internal coil patterns to protrude externally from the ends of the internal coil patterns.

Spaces between the plurality of protruding portions may be filled with a material the same as a material forming the magnetic body.

The electronic component may further include external electrodes disposed on outer surfaces of the magnetic body and connected to the lead parts.

The external electrodes may be connected to the plurality of protruding portions of the lead parts.

Spaces between the plurality of protruding portions may be filled with a material the same as a material forming the magnetic body such that the plurality of protruding portions contact the external electrodes.

Coupling force between the magnetic body and the external electrodes may be greater than coupling force between the plurality of protruding portions and the external electrodes.

The coil pattern may be formed by a plating process.

The coil pattern may include a first coil pattern disposed on one surface of an insulating substrate and a second coil pattern disposed on the other surface of the insulating substrate opposing the one surface of the insulating substrate.

The insulating substrate may include a through-hole penetrating through a central portion thereof, and the through-hole of the insulating substrate may be filled with a material the same as a material forming the magnetic body.

The magnetic body may include a magnetic metal powder and a thermosetting resin.

According to another aspect of the present disclosure, a method of manufacturing an electronic component may include forming coil patterns on an insulating substrate, and providing magnetic sheets on an upper surface and a lower surface of the insulating substrate on which the coil patterns are formed, to form a magnetic body. The coil patterns may include internal coil parts having a spiral shape and lead parts connected to ends of the internal coil patterns and exposed to surfaces of the magnetic body, and the lead parts may include a plurality of protruding portions spaced apart from each other and connected to the ends of the internal coil parts to protrude externally from the ends of the internal coil parts.

Spaces between the plurality of protruding portions may be filled with a material the same as a material forming the magnetic body.

The method of manufacturing an electronic component may further include forming external electrodes on outer surfaces of the magnetic body to be connected to the lead parts.

The external electrodes may be formed to be connected to the plurality of protruding portions of the lead parts.

The external electrodes may be formed to be in contact with regions of spaces between the plurality of protruding portions in the magnetic body, the regions being filled with a material the same as a material forming the magnetic body.

Coupling force between the magnetic body and the external electrodes may be greater than coupling force between the plurality of protruding portions and the external electrodes.

The coil patterns may be formed by a plating process.

The method of manufacturing an electronic component may further include removing a central portion of the insulating substrate so as to form a core part hole and filling the core part hole formed in the insulating substrate with a same magnetic material for forming the magnetic body.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a schematic perspective view illustrating an electronic component according to an exemplary embodiment in the present disclosure so that coil patterns of the electronic component are visible; FIG. 2 is a cross-sectional view taken along line I-I′ of FIG. 1;

FIG. 3 is a cross-sectional view of the electronic component of FIG. 1 when viewed from a T direction; and

FIG. 4 is a schematic process flow chart describing a manufacturing process of an electronic component according to an exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Electronic Component

Hereinafter, an electronic component according to an exemplary embodiment, particularly, a thin film type inductor, will be described as an example. However, the electronic component according to the exemplary embodiment is not limited thereto.

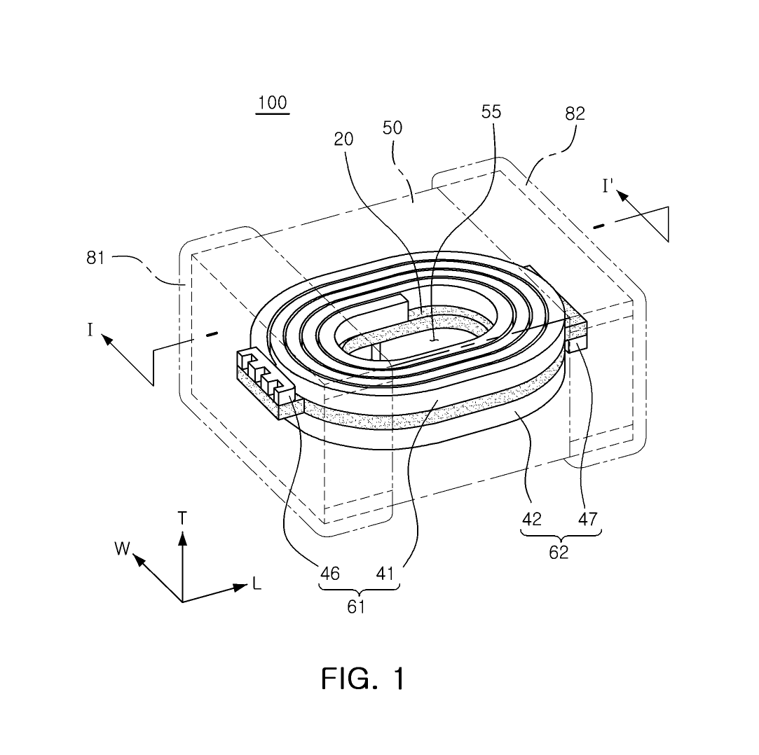

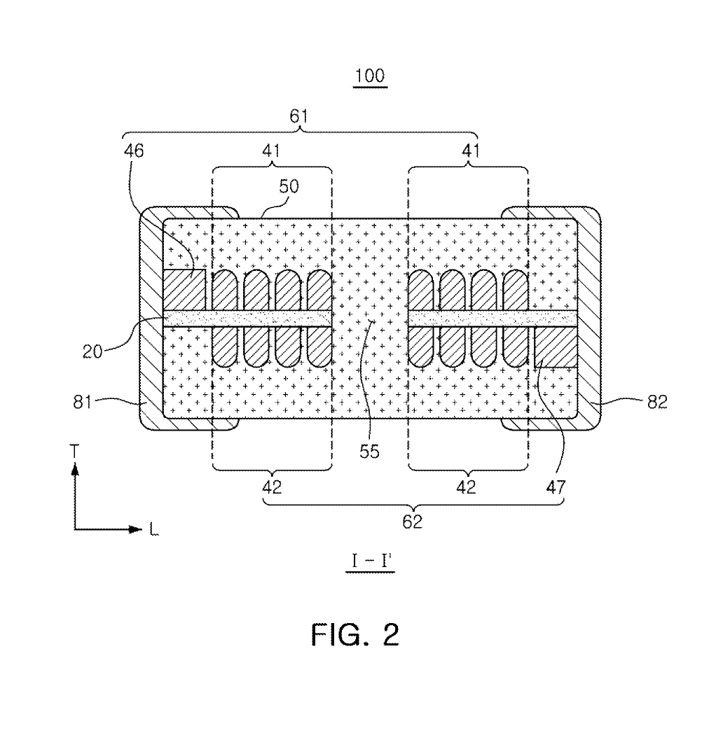

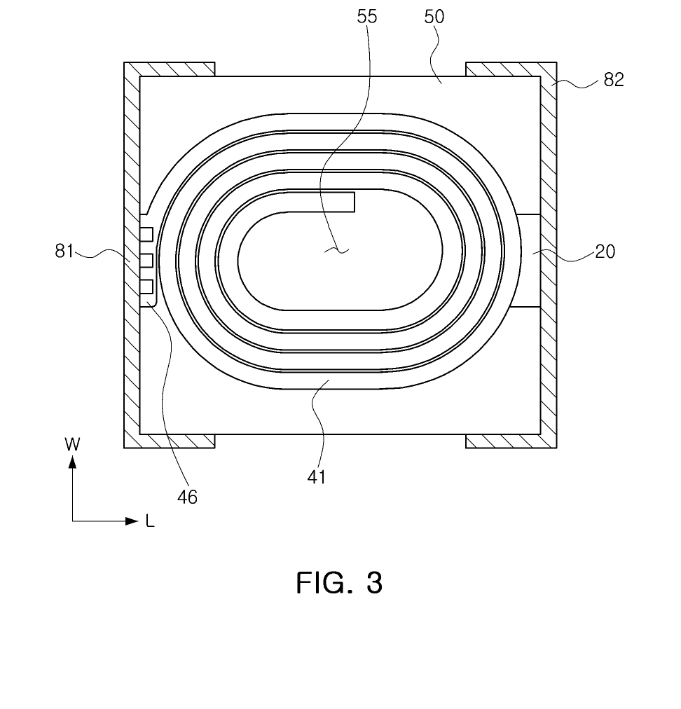

FIG. 1 is a schematic perspective view illustrating an electronic component according to an exemplary embodiment so that internal coil patterns of the electronic component are visible and FIG. 2 is a cross-sectional view taken along line I-I′ of FIG. 1. In addition, FIG. 3 is a cross-sectional view of the electronic component of FIG. 1 when viewed from a T direction.

Referring to FIGS. 1 through 3, as an example of an electronic component, a thin film type inductor used in a power line, or the like, of a power supply circuit is disclosed.

The electronic component 100, according to an exemplary embodiment, may include a magnetic body 50, coil patterns 61 and 62 embedded in the magnetic body 50, and first and second external electrodes 81 and 82 disposed on outer surfaces of the magnetic body 50 and connected to the coil patterns 61 and 62, respectively.

In FIG. 1, a “length” direction refers to an “L” direction of FIG. 1, a “width” direction refers to a “W” direction of FIG. 1, and a “thickness” direction refers to a “T” direction of FIG. 1.

The shape of the magnetic body 50 may form the shape of the electronic component 100 and may be formed of any material that exhibits magnetic properties. For example, the magnetic body 50 may be formed by providing ferrite or magnetic metal particles in a resin part.

As a specific example of the above-mentioned materials, the ferrite may be made of an Mn—Zn-based ferrite, an Ni—Zn-based ferrite, an Ni—Zn—Cu-based ferrite, an Mn-Mg-based ferrite, a Ba-based ferrite, an Li-based ferrite, or the like, and the magnetic body 50 may have a form in which the above-mentioned ferrite particles are dispersed in epoxy, polyimide, phenol based resin, or the like.

In addition, the magnetic metal particles may contain anyone or more selected from the group consisting of iron (Fe), silicon (Si), chromium (Cr), aluminum (Al), and nickel (Ni). For example, the magnetic metal particles may be an Fe—Si—B—Cr based amorphous metal, but are not limited thereto. The magnetic metal particles may have a diameter of about 0.1 μm to 34 μm, and the magnetic body 50 may have a form in which the above-mentioned magnetic metal particles are dispersed in the resin such as epoxy, polyimide, or the like, similar to the ferrite described above.

As illustrated in FIGS. 1 and 2, the first coil pattern 61 may be disposed on one surface of an insulating substrate 20 disposed in the magnetic body 50, and the second coil pattern 62 may be disposed on the other surface of the insulating substrate 20 opposing one surface of the insulating substrate 20. In this case, the first and second coil patterns 61 and 62 may be electrically connected to each other through a via (not illustrated) formed to penetrate through the insulating substrate 20.

The insulating substrate 20 may be, for example, a polypropylene glycol (PPG) substrate, a ferrite substrate, a metal based soft magnetic substrate, or the like. The insulating substrate 20 may have a through-hole formed in a central portion thereof so as to penetrate through the central portion thereof, wherein the through-hole may be filled with magnetic material to form a core part 55. As such, the core part 55 filled with the magnetic material may be formed, thereby improving performance of a thin film type inductor.

The first and second coil patterns 61 and 62 may each be formed in a spiral shape and may include internal coil parts 41 and 42 serving as a main region of a coil, and lead parts 46 and 47 connected to ends of the internal coil parts 41 and 42 and exposed to surfaces of the magnetic body 50. In this case, the lead parts 46 and 47 may be formed by extending one end portion of each of the internal coil parts 41 and 42, and may be exposed to surfaces of the magnetic body 50 so as to be connected to the first and second external electrodes 81 and 82 disposed on the outer surfaces of the magnetic body 50. In particular, as described below, the lead parts 46 and 47 may include a plurality of protruding portions as a structure for improving adhesive strength between the lead parts 46 and 47 and the external electrodes 81 and 82.

The first and second coil patterns 61 and 62 and a via (not illustrated) maybe formed of a material including a metal having excellent electrical conductivity, and may be formed of silver (Ag), palladium (Pd), aluminum (Al), nickel (Ni), titanium (Ti), gold (Au), copper (Cu), platinum (Pt), or alloys thereof. In this case, as an example of a process of forming the first and second coil patterns 61 and 62 in a thin film shape, the first and second coil patterns 61 and 62 may be formed by performing an electroplating method. However, other processes known in the art may also be used as long as they have a similar effect.

The external electrodes 81 and 82 may be provided as external terminals of the electronic component 100 and may be formed of a material including a metal having excellent electrical conductivity. For example, the external electrodes 81 and 82 may be formed of a material such as nickel (Ni), copper (Cu), tin (Sn), or silver (Ag), or alloys thereof, and may also be formed of a composite of a metal material and a resin. Plated layers (not illustrated) may be further formed on the external electrodes 81 and 82. In this case, the plated layers may contain one or more selected from the group consisting of nickel (Ni), copper (Cu), and tin (Sn). For example, a nickel (Ni) layer and a tin (Sn) layer may be sequentially formed.

According to the present exemplary embodiment, as illustrated in FIG. 1, the lead parts 46 and 47 may each include a plurality of protruding portions. The plurality of protruding portions may be connected to ends of the internal coil parts 41 and 42 to protrude externally from the ends of the internal coil parts 41 and 42 and may be formed to be spaced apart from each other. In this case, regions between the plurality of protruding portions in the lead parts 46 and 47 may be filled with the material the same as that forming the magnetic body 50. Since the lead parts 46 and 47 include the plurality of protruding portions and the material the same as that forming the magnetic body 50 is filled between the plurality of protruding portions, coupling force between the external electrodes 81 and 82 and the coil patterns 61 and 62 may be improved, and breakage defects, which may be caused during a manufacturing process, may also be reduced.

In a case in which the lead parts 46 and 47 of the coil patterns 61 and 62 and the external electrodes 81 and 82 are weakly coupled to each other, delamination may occur by thermal shock at the time an electronic component is manufactured or during a process of utilizing the electronic component, and a delaminated and exposed region as described above may be oxidized. As a result, there is a problem that electrical resistance is significantly increased or an open defect occurs in a connection region of the lead parts 46 and 47 and the external electrodes 81 and 82. In addition, as the region of the lead parts 46 and 47 externally exposed from the magnetic body 59 is increased, stress caused by processes such as a cutting, polishing, or the like, may be transferred to the internal coil parts 41 and 42. As an amount of the magnetic body 50 present around a cut region is small, for instance, the magnetic body 50 is thin, an influence of the above-mentioned stress may be increased.

According to the present exemplary embodiment, by taking the above-mentioned problems into account, the lead parts 46 and 47 may be formed to be divided into the plurality of protruding portions and the above-mentioned protruding portions may be connected to the external electrodes 81 and 82. According to examples of various materials which may be used in the present exemplary embodiment, coupling force between the magnetic body 50 and the external electrodes 81 and 82 may be greater than that between the lead parts 46 and 47 and the external electrodes 81 and 82. Thus, spaces between the plurality of protruding portions formed in the lead parts 46 and 47 are filled with the material the same as that forming the magnetic body 50, and thus the external electrodes 81 and 82 may be more stably connected to the lead parts 46 and 47.

For instance, adhesive strength between the lead parts 46 and 47 formed to be divided into a plurality of protruding portions and the external electrodes 81 and 82 may be increased. As a result, electrical resistance may be reduced and reliability against thermal shocks may be improved.

In addition, the relatively increased region of the magnetic body 50 may significantly reduce the influence of stress on the internal coil regions in the following process as described above, thereby contributing to improve performance and reliability of the electronic component. A useful effect described above may further be increased as the magnetic body 50 is thin. Here, a case in which the magnetic body 50 is thin may be defined as a form in which a thickness of cover regions covering an upper portion and a lower portion of the coil patterns 61 and 62 in the magnetic body 50 is about 150 μm or less.

Meanwhile, the internal coil parts 41 and 42 and the lead parts 46 and 47 may be formed by a plating process. In a case in which the internal coil parts 41 and 42 and the lead parts 46 and 47 are formed by performing the plating process, the thickness of the lead parts 46 and 47 may be appropriately adjusted by adjusting current density, concentration of a plating solution, plating speed, or the like. In this case, the protruding portions of the lead parts 46 and 47 may be manufactured by patterning and etching processes which are known in the art and may also be naturally formed during a process of forming the lead parts 46 and 47 by a plating process, or the like. For instance, regions in which the protruding portions are to be formed are filled with another material in advance, and thus the lead parts 46 and 47 may not be formed during the plating process, or the like. As such, the plurality of protruding portions of the lead parts 46 and 47 proposed by the present exemplary embodiment may be obtained by various methods.

Method of manufacturing Electronic Component

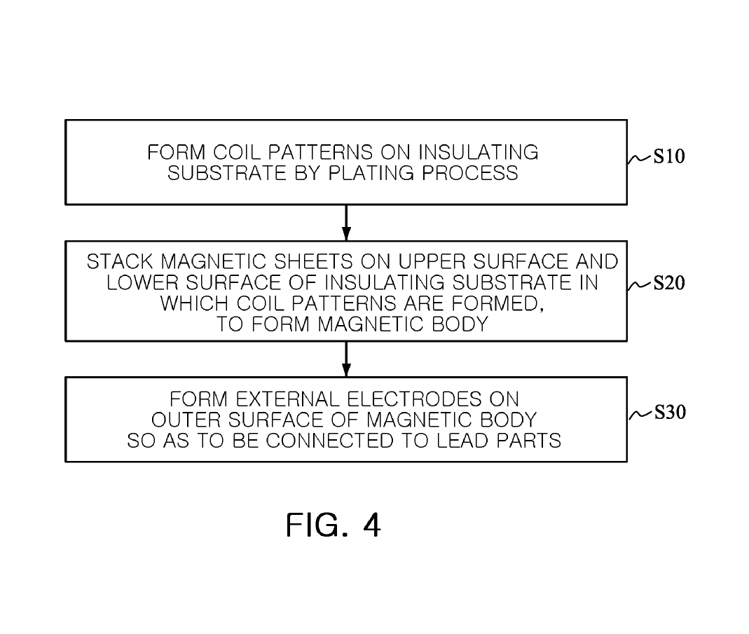

FIG. 4 is a process flow chart schematically describing a manufacturing process of an electronic component according to an exemplary embodiment. A method of manufacturing an electronic component, according to the present exemplary embodiment, will be described with reference to FIGS. 1 through 4.

First, coil patterns 61 and 62 may be formed on an insulating substrate 20 (S10). Here, a plating may be used, but is not necessarily used. As described above, the coil patterns 61 and 62 may include the internal coil parts 41 and 42 of the spiral shape, and the lead parts 46 and 47 formed by extending one end portion of each of the internal coil parts 41 and 42.

As described above, according to the present exemplary embodiment, the lead parts 46 and 47 may be formed to have the plurality of protruding portions as the structure for improving adhesive strength with the external electrodes to be formed in the following process. In this case, the internal coil parts 41 and 42 and the lead parts 46 and 47 may be formed by performing the plating process, and a thickness, or the like thereof, may be appropriately adjusted by adjusting current density, concentration of a plating solution, plating speed, or the like. In addition, as described above, the protruding portions of the lead parts 46 and 47 may be manufactured by patterning and etching processes which are known in the art and may also be naturally formed during the process of forming the lead parts 46 and 47 by the plating process, or the like.

Meanwhile, although not illustrated in FIGS. 1 and 2, in order to further protect the coil patterns 61 and 62, an insulating film (not illustrated) coating the coil patterns 61 and 62 may be formed, wherein the insulating film may be formed by a known method such as a screen printing method, an exposure and development method of a photo-resist (PR), a spray applying method, or the like.

Next, the magnetic sheets may be stacked on upper and lower surfaces of the insulating substrate 20 on which the coil patterns 61 and 62 are formed, and the stacked magnetic sheets may then be compressed and cured to form the magnetic body 50 (S20). The magnetic sheets may be manufactured in a sheet shape by preparing slurry by mixtures of magnetic metal powder, and organic materials such as a binder, a solvent, and the like, applying the slurry at a thickness of several tens of micrometers onto carrier films by a doctor blade method, and then drying the slurry. As described in the present exemplary embodiment, the spaces between the lead parts 46 and 47 of the coil patterns 61 and 62, for instance, the spaces between the plurality of protruding portions, are filled with the material the same as that forming the magnetic body 50, and thus the electronic component 100 having improved electrical and mechanical characteristics may be provided.

A central portion of the insulating substrate 20 may be removed by performing a mechanical drilling process, a laser drilling, sandblasting, a punching process, or the like to form a core part hole, and the core part hole may be filled with the magnetic material in the process of stacking, compressing, and curing the magnetic sheets to form the core part 55.

Next, the first and second external electrodes 81 and 82 may be formed on the outer surfaces of the magnetic body 50 so as to be connected, respectively, to the lead parts 46 and 47 exposed to surfaces of the magnetic body 50 (S30). The external electrodes 81 and 82 maybe formed of a paste containing a metal having excellent electrical conductivity such as a conductive paste containing nickel (Ni), copper (Cu), tin (Sn), or silver (Ag), or alloys thereof. In addition, the external electrodes 81 and 82 may be formed of a composite of a metal material and a resin.

A description of features overlapping those of the electronic component according to the exemplary embodiment described above except for the above-mentioned description will be omitted.

As set forth above, according to an exemplary embodiment, the electronic component having improved electrical characteristics and reliability against thermal shock, and the like, by securing sufficient coupling force between the internal coil regions and the external electrodes may be provided, and further, the method having efficient manufacturing of the electronic component may be provided. In addition, as the coupling force between the internal coil regions and the external electrodes is improved, breakage defects, which may be caused at the time when a slimmed electronic component is manufactured, may be reduced.

While exemplary embodiments have been shown and described above, it will be apparent to those skilled in the art that modifications and variations could be made without departing from the scope of the present invention as defined by the appended claims.

What is claimed is:

1. An electronic component comprising:
a magnetic body; and
a coil pattern embedded in the magnetic body and including internal coil parts having a spiral shape and lead parts connected to ends of the internal coil parts and externally exposed from the magnetic body,
wherein the lead parts include a plurality of protruding portions spaced apart from each other and connected to the ends of the internal coil parts to protrude externally from the ends of the internal coil parts.

2. The electronic component of claim 1, wherein spaces between the plurality of protruding portions are filled with a material the same as a material forming the magnetic body.

3. The electronic component of claim 1, further comprising external electrodes disposed on outer surfaces of the magnetic body and connected to the lead parts.

4. The electronic component of claim 3, wherein the external electrodes are connected to the plurality of protruding portions of the lead parts.

5. The electronic component of claim 4, wherein spaces between the plurality of protruding portions are filled with a material the same as a material forming the magnetic body such that the plurality of protruding portions contact the external electrodes.

6. The electronic component of claim 5, wherein coupling force between the magnetic body and the external electrodes is greater than coupling force between the plurality of protruding portions and the external electrodes.

7. The electronic component of claim 1, wherein the coil pattern is formed by a plating process.

8. The electronic component of claim 1, wherein the coil pattern comprises a first coil pattern disposed on one surface of an insulating substrate and a second coil pattern disposed on the other surface of the insulating substrate opposing the one surface of the insulating substrate.

9. The electronic component of claim 8, wherein the insulating substrate includes a through-hole penetrating through a central portion thereof, and the through-hole of the insulating substrate is filled with a material the same as a material forming the magnetic body.

10. The electronic component of claim 1, wherein the magnetic body includes a magnetic metal powder and a thermosetting resin.

11. A method of manufacturing an electronic component, the method comprising:
forming coil patterns on an insulating substrate; and
providing magnetic sheets on an upper surface and a lower surface of the insulating substrate on which the coil patterns are formed, to form a magnetic body,
wherein the coil patterns include internal coil parts having a spiral shape and lead parts connected to ends of the internal coil parts and exposed to surfaces of the magnetic body, and the lead parts include a plurality of protruding portions spaced apart from each other and connected to the ends of the internal coil parts to protrude externally from the ends of the internal coil parts.

12. The method of claim 11, wherein spaces between the plurality of protruding portions are filled with a material the same as a material forming the magnetic body.

13. The method of claim 11, further comprising forming external electrodes on outer surfaces of the magnetic body to be connected to the lead parts.

14. The method of claim 13, wherein the external electrodes are formed to be connected to the plurality of protruding portions of the lead parts.

15. The method of claim 14, wherein the external electrodes are formed to be in contact with regions of spaces between the plurality of protruding portions in the magnetic body, the regions being filled with a material the same as a material forming the magnetic body.

16. The method of claim 15, wherein coupling force between the magnetic body and the external electrodes is greater than coupling force between the plurality of protruding portions and the external electrodes.

17. The method of claim 11, wherein the coil patterns is formed by a plating process.

18. The method of claim 11, further comprising:
removing a central portion of the insulating substrate so as to form a core part hole; and
filling the core part hole formed in the insulating substrate with a same magnetic material for forming the magnetic body.
